(19) United States
(12) Patent Application Publication
(10) Pub. No.: US 2025/0229233 A1
(43) Pub. Date: Jul. 17, 2025

(54) Virus-Removal Composite Membrane and Preparation Process Thereof

(71) Applicant: Hangzhou Cobetter Filtration Equipment Co., Ltd., Hangzhou (CN)

(72) Inventors: Jiandong Jia, Hangzhou (CN); Hongxing Lu, Hangzhou (CN)

(21) Appl. No.: 19/171,363

(22) Filed: Apr. 7, 2025

Related U.S. Application Data
(63) Continuation of application No. PCT/CN2023/110371, filed on Jul. 31, 2023.

(30) Foreign Application Priority Data
Oct. 27, 2022 (CN) 202211330275.2

(51) Int. Cl. B01D 69/12; B01D 67/00; B01D 71/38; B01D 71/68

(52) U.S. Cl. CPC B01D 69/12; B01D 67/0011; B01D 67/0013; B01D 67/0016; B01D 71/381; B01D 71/68; B01D 2325/022; B01D 2325/02833; B01D 2325/02834; B01D 2325/04; B01D 2325/24

(57) ABSTRACT

Disclosed are a virus-removal composite membrane and a preparation method thereof. A virus-removal composite membrane comprises a main body, wherein the main body comprises: a porous substrate layer including a liquid inlet surface and a separation layer including a liquid outlet surface, the porous substrate layer is a microporous membrane layer formed by a first polymer, the separation layer is formed by a second polymer, and the first polymer and the second polymer are different polymer materials; in a region of the porous substrate layer close to one side of the separation layer, the second polymer permeates from a surface of the porous substrate layer into a pore structure of the porous substrate layer to form a bonding region, and pores formed by the second polymer in the bonding region are connected to pores of the separation layer.

### CROSS-REFERENCE TO RELATED APPLICATIONS

This application is a continuation of International Application No. PCT/CN2023/110371, filed on Jul. 31, 2023, which claims priority to Chinese Patent Application No. 202211330275.2, filed on Oct. 27, 2022. All of the aforementioned applications are incorporated herein by reference in their entireties.

### TECHNICAL FIELD

The present disclosure relates to the technical field of virus-removal filtration, and in particular to a virus-removal composite membrane and a preparation process thereof.

### BACKGROUND

As a new contemporary technology for high-efficiency separation, the membrane technology has such advantages as high separation efficiency, low energy consumption and small occupied area compared with traditional technologies including distillation and rectification. The core of the membrane separation technology is a separation membrane, wherein a polymer filter membrane is a type of separation membranes prepared by using organic high polymers as raw materials according to a certain process. Along with development of the petroleum industry and science and technology, the application fields of the polymer filter membrane are continuously expanding, and the polymer filter membrane has been applied to such fields as gas separation, seawater desalination, ultra-pure water preparation, sewage treatment, manufacturing of artificial organs, medicine, food, agriculture, and chemical industry.

According to different types of high polymers, the polymer filter membranes are subdivided into cellulose polymer filter membranes, polyamide polymer filter membranes, sulfone polymer filter membranes, polytetrafluoroethylene polymer filter membranes and so on; and in addition, the polymer filter membranes are also divided into micro-filtration membranes, ultrafiltration membranes, nanofiltration membranes and reverse osmosis membranes according to the pore size of membranes.

In recent years, since biotechnological products derived from cell lines may be contaminated by viruses, therefore, during production of biologics, removal or inactivation of viruses has always been the key to research. Removal or inactivation of viruses is capable of significantly reducing iatrogenic transmission of pathogenic viruses and reducing risks, and is of great significance to product safety. Before entering clinical trials and appearing on the market, biological products must demonstrate an ability to remove known and presumed viruses in their production process.

At present, in biological product companies, a fine pore size of an ultrafiltration membrane cortex is mainly used for filtration and retention of viruses, so as to ensure removal of viruses from biological products and improve safety of biological products. At present, the common virus-removal filter membrane includes a virus-removal filter membrane with a single-layer structure and a virus-removal filter membrane with a double-layer structure. The virus-removal filter membrane with a single-layer structure typically includes an asymmetric polyethersulfone filter membrane, an ultrafiltration cortex structure is arranged on the surface of the polyethersulfone filter membrane, and is capable of intercepting viruses; and a portion below the ultrafiltration cortex is arranged to pre-filter the filtered fluid. One of the layers of the virus-removal filter membrane with a double-layer structure is a separation membrane layer provided with an ultrafiltration cortex, and the other layer is a supporting layer provided with a microporous structure, and the supporting layer is capable of improving integrity of the separation layer on the virus-removal filter membrane.

A multi-layer composite ultrafiltration membrane is disclosed in a Chinese patent application filed by EMD Millipore Corporation with an authorized announcement number of CN1759924B, wherein the composite ultrafiltration membrane includes at least one first porous membrane layer having a first face and an equivalent second face, and at least one second porous membrane layer having a first face and a second face which are equivalent, wherein the first layer is superimposed with the second layer, and a porosity connection transition region from an equivalent first face of the second layer to an equivalent second face of the first layer is formed, wherein at least one of the layers is an asymmetric ultrafiltration membrane; such a compositely formed membrane structure has a strong retention effect on parvovirus, and at the same time a higher protein yield is obtained, thereby satisfying the needs of practical applications.

As to a microporous layer and an ultrafiltration layer of the composite ultrafiltration membrane in the present disclosure, solutions with two different LCSTs (Lower Critical Solution Temperatures) or UCSTs (Upper Critical Solution Temperatures) are simultaneously co-cast, before a non-solvent phase inversion process, the temperatures of two layers of liquid are controlled to be between the two LCSTs or the two UCSTs, and then a non-solvent phase inversion process is performed to obtain a composite ultrafiltration membrane containing a transition region. The transition region in the composite ultrafiltration membrane has continuous pores, to avoid the appearance of dense regions when an ultrafiltration layer is cast on prefabricated microporous membranes, such that the composite ultrafiltration membrane blocks virus impurities by diffusion, and the membrane flux is improved to a certain extent.

However, an ideal transition region with better performance of the composite ultrafiltration membrane may be obtained by strictly controlling the thickness of the first layer and the second layer, the relative viscosity of the solution, and the relative time to form the layer, and therefore, the double-layer virus-removal filter membrane prepared using this method is more complex and more cumbersome in process, and has more difficulty in adapting to various scenarios with different requirements.

A double-layer PVDF double-layer membrane, e.g., the Viresolve@ membrane, is produced by Millipore Corporation of Billerica, Massachusetts through casting an ultrafiltration layer on a prefabricated microporous membrane, and the double-layer membrane is primarily used for virus-removal filtration of biological products. However, researches have proved that as to the double-layer or multi-layer membrane materials obtained by casting an ultrafiltration layer on the prefabricated microporous membrane, since solutes retained at an interface between two layers are undesirably accumulated before the cast ultrafiltration layer is molded, an obvious dense layer structure is formed at the interface between the two layers, and this layer of dense structure will greatly reduce the membrane flux of the filter flow and shorten the service life of the membranes.

### SUMMARY

The objective of the present disclosure is to provide a virus-removal composite membrane and a preparation process thereof, wherein a bonding region is formed in a porous substrate layer which plays a supporting role in the virus-removal composite membrane, such that a dense layer structure formed when the cast ultrafiltration layer is molded is eliminated, and the flux of the virus-removal composite membrane is greatly improved on the premise that various performances of the virus-removal composite membrane do not attenuate to a great extent.

In a first aspect, the present disclosure provides a virus-removal composite membrane and adopts the following technical solutions.

A virus-removal composite membrane includes a main body, wherein an outer surface on one side of the main body is a liquid inlet surface, an outer surface on another side is a liquid outlet surface, and the main body includes:
a porous substrate layer including the liquid inlet surface and a separation layer including the liquid outlet surface, wherein an average pore size of the porous substrate layer is greater than an average pore size of the separation layer;
the porous substrate layer is a microporous membrane layer formed by a first polymer, the separation layer is formed by a second polymer, and the first polymer and the second polymer are different polymer materials;
in a region of the porous substrate layer close to one side of the separation layer, the second polymer permeates from a surface of the porous substrate layer into a pore structure of the porous substrate layer to form a bonding region, and pores formed by the second polymer in the bonding region are connected to pores of the separation layer; and

In the present disclosure, a PMI pore size is obtained by testing via a Porous Materials Inc pore size tester. a PMI average pore size of the virus-removal composite membrane is controlled to be 15-25 nm; and an average pore size of the bonding region measured by a scanning electron microscope (SEM) is greater than or equal to 50 nm.

Through a test of the average pore size of the filter membrane by a PMI pore size tester, a PMI average pore size of 15-25 nm of the filter membrane in the present disclosure is obtained, and then through a zigzag pathway of the main body structure and a certain thickness of the membrane, the virus-removal composite membrane is ensured to have a better retention effect on the fine virus impurities (e.g., parvoviruses of about 20 nm), and may satisfy the actual virus-removal application requirements.

The virus-removal composite membrane of the present disclosure is prepared by casting a casting solution for forming a separation layer onto a prefabricated porous substrate layer. The prefabricated porous substrate layer is arranged to pre-filter the fluid, such that impurities with a larger particle size in the fluid may be retained in the porous substrate layer, and are not easy to enter the separation layer to make the separation layer prematurely clogged, thereby improving the load of the virus-removal filter membrane; the porous substrate layer is also capable of playing a supportive role, such that the integrity of the membrane of the cast separation layer may be improved, and the strength of the virus-removal composite membrane is also improved. Secondly, the thickness of the porous substrate layer is adjusted according to actual requirements, such that the virus-removal composite membrane is more flexibly applied to various separation scenarios.

The separation layer and the porous substrate layer of the virus-removal composite membrane in the present disclosure are made of two different materials, and the material used to form the separation layer partially permeates into the porous substrate layer to form a bonding region. Wherein, the porous substrate layer is prefabricated from a first polymer and the separation membrane layer is cast from a second polymer. Different materials are capable of avoiding mutual dissolution or excessive adhesion between the first polymer and the second polymer after the second polymer is permeated into the porous substrate layer, thereby ensuring that the second fiber formed from the second polymer and the first fiber formed from the first polymer within the bonding region are basically discontinuous, and further avoiding a substantial decrease in the membrane flux of the virus-removal composite membrane caused by localized crusting or agglomeration. At the same time, if the porous substrate layer and the casting solution are miscible to a certain extent, an interface between the porous substrate layer and the separation layer becomes more uneven, and integrity of the membrane of a separation layer after a phase inversion process will be reduced.

Secondly, the second polymer in the bonding region is formed by permeating along interconnected pore structures of the porous substrate layer, and a favorable transition between the pore structure of the porous substrate layer and the pore structure of the separation layer is achieved through the bonding region, such that the second polymers are not undesirably accumulated on the surface of the porous substrate layer and the separation layer or in the porous substrate layer, thereby promoting connectivity between the porous substrate layer and the separation layer, improving the membrane flux of the virus-removal composite membrane, and also increasing the bonding strength between the porous substrate layer and the separation layer.

In addition, when the SEM average pore size of the pore within the bonding region in the virus-removal composite membrane of the present disclosure is measured, a scanning electron microscope is used to perform morphology characterization on the membrane cross-sectional structure, and measurement is performed using computer software (e.g., Matlab, NIS-Elements, etc.) or manually, and then corresponding computation is performed. Of course, those skilled in the art may also obtain the above parameters through other measurement means, and the above measurement means are merely for reference.

It is found through measurement that the average pore size of the bonding region measured by an SEM should not be less than 50 nm, to ensure that the composite membrane may have a larger membrane flux and obtain a better pre-filtration effect and a better bonding strength. If the SEM average pore size of the bonding region is less than 50 nm, the possibility of forming a dense structure within the bonding region is greatly increased, and once a dense region is formed, the flux will be dramatically decreased. Therefore, the SEM average pore size of the bonding region should not be less than 50 nm after the composite membrane is molded.

Further, the average pore size of the bonding region measured by an SEM is 50-500 nm, and a thickness of the bonding region is greater than or equal to 10 μm.

When the thickness of the bonding region is measured, a scanning electron microscope is used to perform morphology characterization on the membrane structure, and then measurement is performed using computer software (e.g., Matlab, NIS-Elements, etc.) or manually. Of course, those skilled in the art may also obtain the above parameters through other measurement means, and the above measurement means are merely for reference.

When the thickness of the bonding region of the virus-removal composite membrane in the present disclosure is greater than or equal to 10 μm, the bonding region is capable of significantly improving the bonding strength between the porous substrate layer and the separation layer. When the thickness of the bonding region is less than 10 μm, the bonding strength between the separation layer and the porous substrate layer is significantly weakened, such that two membrane layers are prone to be separated in the subsequent application of the virus-removal composite membrane.

Secondly, when the average pore size of the bonding region measured by an SEM is 50-500 nm, the membrane flux and the pre-filtration effect of the virus-removal composite membrane all reach a higher level. If the average pore size of the bonding region measured by an SEM is less than 50 nm, on the one hand, a dense region may be formed in the bonding region, thereby leading to a significant decrease in the flux of the bonding region; on the other hand, if the pore size of the bonding region is too small, a larger amount of protein in the fluid will be adsorbed, and the protein yield of the fluid will be reduced. If the average pore size of the bonding region measured by an SEM is too large, then the bonding strength between the separation layer and the porous substrate layer will also be dramatically weakened. Since the pore size of the bonding region is obtained after the second polymer permeates into the molded pore structure of the first polymer, an overlarge pore size indicates weaker interaction between the second fiber and the first fiber formed by permeation of the second polymer in the bonding region and a poorer bonding strength between the separation layer and the porous substrate layer.

Further, the thickness of the bonding region accounts for 30-70% of a thickness of the porous substrate layer, and the thickness of the bonding region is 15-30 μm.

By adopting the above technical solution, the thickness of the porous substrate layer accounted for by the bonding region should not be too large or too small, since if the proportion of the bonding region is too small, on the one hand, the bonding strength between the separation layer and the porous substrate layer becomes weaker, and such problems as peeling or damage may easily occur in subsequent applications including folding; on the other hand, the transition effect of the bonding region becomes unobvious, and undesired accumulation of solvent may not be alleviated, and the membrane flux of the virus-removal composite membrane will also be dramatically reduced.

Secondly, if the proportion of the bonding region is too large, the average pore size of the bonding region is smaller than the original average pore size of the porous substrate layer, thereby leading to an unavoidable loss of the membrane flux. Moreover, the pore of the porous substrate layer used for pre-filtration is correspondingly reduced, and then the performance such as membrane load will also be greatly affected.

In addition, when the thickness ratio of the bonding region to the porous substrate layer is controlled to be 30-70%, the thickness of the bonding region is 15-30 μm, then the bonding region plays a better transitional role between the separation layer and the porous substrate layer, and the flux and the mechanical strength of the composite membrane are further improved.

Further, a ratio of the thickness of the bonding region to a thickness of the separation layer is 1:(0.5-2).

By adopting the above technical solution, the ratio of the thickness of the bonding region to the thickness of the separation layer should not be too large or too small, since the separation layer is usually prepared by a casting solution phase inversion method, and once the ratio of the thickness of the bonding region to the thickness of the separation layer is too small or too large, the pore structure formed by phase separation of the casting solution in the bonding region has difficulty in obtaining a pore structure with a relatively high porosity or good connectivity, and may even lead to a substantial decrease in the membrane flux caused by blocking. Secondly, if the ratio of the thickness of the bonding region to the thickness of the separation layer is too small, e.g., the separation layer is thicker and the bonding region is thinner, then the thicker separation layer is difficult to be well bonded to the porous substrate layer through the bonding ability of the bonding region.

Further, the thickness of the bonding region has a standard deviation σ of less than or equal to 3 μm in both the length direction and the width direction.

As to the standard deviation of the thickness of the bonding region, a certain number of positions at equal intervals may be selected along a length direction on the cross section of the bonding region in a cross-sectional electron microscope diagram of the length direction or the width direction, the thickness at these positions is measured using computer software (e.g., Matlab, NIS-Elements, etc.) or manually, and the standard deviation thereof is calculated. Of course, those skilled in the art may also obtain the above parameters through other measurement means, and the above measurement means are merely for reference.

When the standard deviation of the thickness of the bonding region in the length direction and the width direction is not more than 3 μm, the boundary between the bonding region and the porous substrate layer is clearer, and the transition between the pore structure of the bonding region and the pore structure of the porous substrate layer is better, the resistance exerted onto the fluid at different positions in the membrane is more uniform during filtration, the filtration process is more stable, and the attenuation of the membrane flux is lower.

If the standard deviation of the thickness of the bonding region is too large, it means that the distribution of the region on the side, close to the porous substrate layer, of the bonding region is not uniform, then in the process of filtering fluid, the pressure in each position and the pressure resistance in each position also differ greatly, therefore, the ability of virus removal in some positions on the separation membrane may be probably affected, the virus retention effect becomes poorer, and the membrane flux may also become smaller.

Further, the bonding region includes a first fiber formed from the first polymer, and a second fiber formed from the second polymer; and a SEM average diameter of the first fiber within the bonding region is 0.1 μm to 2 μm, and a SEM average diameter of the second fiber within the bonding region is 0.05 μm to 1 μm.

When the SEM average diameter of the first fiber and the second fiber within the bonding region is measured, a scanning electron microscope is used to perform morphology characterization on the membrane cross-sectional structure, then measurement is performed using computer software (e.g., Matlab, NIS-Elements, etc.) or manually, and then corresponding computation is performed. Of course, those skilled in the art may also obtain the above parameters through other measurement means, and the above measurement means are merely for reference.

By adopting the above technical solution, the SEM average diameter of the first fiber within the bonding region should not be less than 0.1 μm, and if the SEM average diameter is less than 0.1 μm, the first fiber is unable to play a better supporting role, the strength of the bonding region will be substantially reduced, and the bonding between the separation layer and the porous substrate layer will be significantly weakened. Moreover, the SEM average diameter of the first fiber should not be too large, and if the SEM average diameter of the first fiber is greater than 2 μm, the flux within the bonding region will be significantly decreased.

Secondly, the SEM average diameter of the second fiber within the bonding region should not be greater than 1 μm, and if the SEM average diameter of the second fiber is greater than 1 μm, the second fiber may form crusts or clumps within the bonding region, thereby leading to a substantial decrease in the overall flux of the virus-removal composite membrane. The SEM average diameter of the second fiber within the bonding region should not be too small, and if the SEM average diameter is less than 0.05 μm, the second fiber increases the original specific surface area to a greater extent within the pore structure of the porous substrate layer, such that more proteins in the fluid are easily adsorbed when the fluid is filtered, the protein yield is lowered and the overall membrane load is also reduced.

Further, the ratio of the SEM average diameter of the first fiber within the bonding region to the average pore size of the bonding region measured by an SEM is 0.5-2.5, the ratio of the SEM average diameter of the second fiber within the bonding region to the average pore size of the bonding region measured by an SEM is 0.4-0.9, and the average pore size of the bonding region measured by an SEM is 80 nm to 200 nm.

By adopting the above technical solution, since the pore in the bonding region is mainly formed by the first fiber and the second fiber together, when the average pore size of the bonding region measured by an SEM is 80-200 nm and the ratio of the SEM average diameter of the first fiber to the average pore size of the bonding region measured by an SEM is 0.5-2.5, and the ratio of the SEM average diameter of the second fiber to the average pore size of the bonding region measured by an SEM is 0.4-0.9, both the flux and the bonding strength of the virus-removal composite membrane may be taken into account.

Since the diameter of the first fiber plays a major role in influencing the strength of the bonding region and the entire virus-removal composite membrane, the diameter of the first fiber should not be too small. However, the diameter of the first fiber should not be too large under the premise of maintaining a range of the pore size in the bonding region, and if the diameter of the first fiber is too large, the porosity of the porous substrate layer is probably reduced, thereby seriously affecting the membrane flux of the composite membrane.

The second fiber is formed by permeation of the second polymer into the pore structure of the porous substrate layer and phase separation, therefore, the second fiber will directly affect the bonding strength of the bonding region as well as the connectivity of the bonding region. If the diameter of the first fiber is too small, the first fiber is prone to undesired accumulation under a limited range of pore size of the bonding region, thereby resulting in the formation of a dense region and decreasing the membrane flux. Moreover, if the diameter of the first fiber is too small, the pore specific surface area of the original macropores of the porous substrate layer is increased in a disguised manner, and then proteins are more easily adsorbed during filtration, and the protein yield is reduced. If the diameter of the first fiber is too large, the gap formed by the first fiber in the original pore structure of the porous substrate layer is too small or the pores are too few, and then the connectivity in the bonding region is greatly influenced.

Therefore, while ensuring that the SEM average pore size of the bonding region is 80-200 nm, a superior membrane flux, a better bonding strength and a lower protein adsorption rate may be realized only when the diameters of the first fiber and the second fiber also simultaneously satisfy the above conditions.

Further, the ratio of the SEM average pore size of the bonding region to the SEM average pore size of the porous substrate layer is 1:(3-20) in the region where the bonding region is close to the side of the separation layer and the distance from the separation layer is less than 20% of the thickness of the bonding region.

By adopting the above technical solution, when the ratio of the SEM average pore size of the bonding region in the region close to the side of the separation layer to the original SEM average pore size of the porous substrate layer is 1:(3-20), the porosity in the region, close to the separation layer, of the bonding region is higher, and the connectivity between the bonding region and the separation layer is better, such that the membrane flux of the virus-removal composite membrane is further improved. Secondly, the bonding between the separation layer and the porous substrate layer is also enhanced.

Further, the thickness of the separation layer is greater than or equal to 10 μm.

By adopting the above technical solution, if the thickness of the separation layer is less than 10 μm, the integrity of the membrane layer of the separation layer obtained in a phase inversion process of casting solution will be significantly reduced.

Further, the thickness of the separation layer is 10-40 μm, and the pore size of the separation layer decreases in a gradient manner in a thickness direction towards the liquid outlet surface; the separation layer includes a virus-removal region and a transition region in the thickness direction, and a thickness ratio of the transition region to the virus-removal region is 3-20.

By adopting the above technical solution, when the thickness of the separation layer is controlled to be 10-40 μm, the integrity of the separation membrane layer obtained by molding the casting solution after the phase inversion process is better. The pore size of the separation layer decreases in a gradient manner in the thickness direction towards the liquid outlet surface, such that the separation layer is capable of forming a transition region for pre-filtration in the region close to the bonding region, and the separation layer may obtain a better pre-filtration effect.

When the thickness ratio of the virus-removal region and the transition region in the separation layer is controlled to be 3-20, the integrity of the separation layer may be maintained, and the pre-filtration effect of the separation layer is also greatly improved.

Further, the ratio of the thickness of the transition region to the thickness of the bonding region is 0.2-4, an average pore size of the transition region measured by an SEM is 50-100 nm, and the average pore size of the bonding region measured by an SEM is 50-200 nm.

By adopting the above technical solution, the transition region refers to the region of the separation layer used for pre-filtration, while the bonding region is also formed by permeation of the casting solution of the separation layer into the porous substrate layer, and when the ratio of the thickness of the transition region to the thickness of the bonding region is controlled to be 0.2-4, and the average pore size of the transition region measured by an SEM is 50-100 nm and the average pore size of the bonding region measured by an SEM is 50-200 nm, a good continuity exists between the bonding region and the transition region, the transition region and the bonding region are connected better, and the membrane flux of the virus-removal composite membrane is better.

Secondly, if the ratio of the thickness of the transition region to the thickness of the bonding region is too small, it indicates that a larger amount of casting solution permeates into the porous substrate layer, when the pore in the transition region is compared with the pore in the bonding region, the average diameter may differ greatly, and even the pore size may change abruptly from the bonding region to the transition region, thereby lowering the overall membrane flux of the virus-removal filter membrane. Moreover, if the thickness of the transition region is too small, the pre-filtration ability of the separation layer will be weakened, while the porous substrate layer or the bonding region may hardly play a pre-filtration effect close to that of the transition region. If the ratio of the thickness of the transition region to the thickness of the bonding region is too large, then the bonding strength between the separation layer and the porous substrate layer is weakened since the bonding region is thinned.

Further, the average pore size of the liquid outlet surface measured by an SEM is 10-40 nm; and a pore area ratio of the liquid outlet surface is 2% to 15%.

By adopting the above technical solution, the average pore size of the liquid outlet surface measured by an SEM has a critical influence on the virus retention ability of the virus-removal composite membrane. After morphological characterization is performed on the structure of the liquid outlet surface using a scanning electron microscope, measurement is performed using computer software (e.g. Matlab, NIS-Elements, etc.) or manually, and corresponding computation is performed. Of course, those skilled in the art may also obtain the above parameters through other measurement means, and the above measurement means are merely for reference. The average pore size of the liquid outlet surface measured by an SEM is 10-40 nm, and the virus-removal composite membrane is capable of better removing parvoviruses, and the pore area ratio of the liquid outlet surface is 2-15%, thereby ensuring that the virus-removal composite membrane has a better flux.

Further, the average pore size of the porous substrate layer measured by an SEM is greater than or equal to 80 nm, and the thickness of the porous substrate layer is 20-200 μm.

By adopting the above technical solution, the average pore size of the porous substrate layer measured by an SEM is greater than 80 nm, then an overlarge permeation resistance generated since the pore size of the porous substrate layer is too small is prevented, such that the casting solution has difficulty in permeating into the porous substrate layer, and a bonding region with a suitable thickness and a better connectivity with the separation layer may not be formed. Secondly, when the thickness of the porous substrate layer is controlled to be 20-200 μm, the integrity of the separation layer on the virus-removal composite membrane and the mechanical strength of the virus-removal composite membrane are both improved.

Further, the porous substrate layer is an asymmetric membrane layer structure.

Further, the pore size of the porous substrate layer increases in a gradient manner in a direction from the liquid inlet surface towards the bonding region.

Further, the average pore size of the porous substrate layer is changed with a gradient of 1-6 nm/μm.

By adopting the above technical solution, the permeation degree of the casting solution on the porous substrate layer may be better controlled when the pore size of the porous substrate layer increases in a gradient manner towards a direction of the bonding region. Since the region on the side with a large pore size first contacts the casting solution, the casting solution permeates faster at the beginning, and along with a decreased gradient of the pore size, the permeation resistance of the casting solution becomes larger, and the permeation slows down, thereby controlling the permeation degree of the casting solution through controlling the pore size structure of the porous substrate layer which is changed in a gradient manner, and facilitating control.

Further, the porous substrate layer is a symmetric membrane layer structure.

Further, a tensile strength of the virus-removal composite membrane is greater than 3 MPa and an elongation at break is 2% to 10%;
a flux of the virus-removal composite membrane is greater than 600 L*h⁻¹*m⁻²@30 psi;
a log reduction value (LRV) of the virus-removal composite membrane for virus impurities is greater than or equal to 2; and
a protein yield of the virus-removal composite membrane is greater than or equal to 97%.

Important indicators for evaluating the mechanical strength of the filter membrane include a tensile strength and an elongation at break of the filter membrane; under certain conditions, the greater the tensile strength of the filter membrane, the better the mechanical strength of the filter membrane; the tensile strength refers to the ability of the membrane to withstand parallel tensile action; during tests under certain conditions, the membrane sample is subjected to the action of the tensile load until the membrane sample is broken, and the tensile strength and elongation at break may be calculated according to the maximum tensile load corresponding to the breakage of the membrane sample and the change in the size (length) of the membrane sample; both the tensile strength and the elongation at break may be measured by a universal tensile testing machine, and the test methods of the tensile strength are well known in the field, for example, the tensile strength test procedures are explained in detail in ASTM D790 or ISO178; the tensile strength of the filter membrane in the present disclosure is 3-15 MPa, and the elongation at break is 2-10%, indicating that the filter membrane in the present disclosure has a larger tensile strength and elongation at break, the mechanical properties are better with higher industrial practical values, and the filter membrane may fully satisfy the market requirements.

The permeation flux, also known as permeation rate, or flux for short, refers to the amount of material permeated through a unit membrane area in a unit time under a certain operating pressure during a separation process of a filter membrane; the size of the flux reflects the filtration speed; the larger the flux, the faster the membrane filtration speed; the flux of the virus-removal composite membrane in the present disclosure is greater than 600 L*h⁻¹*m⁻²@30 psi, the flux is larger, indicating that the filtration speed is faster, and while ensuring the retention efficiency, the fluid is capable of quickly passing through the filter membrane with lower time costs and higher economic benefits. In addition, the larger flux of the virus-removal composite membrane also indicates that the bonding region of the virus-removal composite membrane is formed with no obvious dense region which may prevent the fluid from passing through the virus-removal composite membrane.

The viruses retained in the present disclosure are mainly various viruses with a particle size of 20 nm and above (for example, murine parvovirus with a particle size of about 20 nm), after retention tests, it is found that the LRV of the virus-removal composite membrane in the present disclosure for various viruses is greater than or equal to 2, indicating that the virus-removal composite membrane has a very large retention rate of viruses, sufficiently retains virus impurities, and satisfies the requirements of practical applications. The protein yield of the virus-removal composite membrane is greater than or equal to 98%, indicating that the effective substance protein in the fluid is not easily adsorbed on the membrane, on the one hand, the membrane pores are not blocked, to ensure that the filter membrane still has a long service life, and on the other hand, it is guaranteed that the content of the effective substance protein in the fluid changes very little, proteins basically will not lose, and economic benefits are ensured. For the test method of virus impurities, please refer to the patents-CN105980037B-Virus-Removal Membrane, CN101816898B-Ultrafiltration Membrane and Preparation Method Thereof, and CN1759924B-Ultrafiltration Membrane and Preparation Method Thereof.

Further, the LRV of the virus-removal composite membrane for virus impurities is 2-4.

In the virus-removal composite membrane made in the present disclosure, the membrane pore of the separation layer of the virus-removal composite membrane is relatively large, such that the virus-removal composite membrane has a very large flux; but at the same time, since the membrane pore is larger, the retention efficiency of the virus-removal composite membrane on the parvoviruses is reduced to a certain extent, in particular for the parvoviruses with a particle size of about 20 nm, the LVR value may not reach 4 (but the LRV value may also be more than or equal to 2.5); in actual use, two layers of membranes may be stacked for use (the LRV value of the two stacked layers of membranes is equal, for example, the LRV of the single-layer membrane is 3, and the LRV of the double-layer membrane is 6), then at this time, various parvoviruses of 20 nm and above may still be efficiently and sufficiently retained with a larger flux; meanwhile, since the membrane pore is larger, the protein yield is still higher.

Further, a difference between a solubility parameter of the first polymer and a solubility parameter of the second polymer is greater than or equal to 2.1.

By adopting the above technical solution, if the difference between the solubility parameter of the first polymer and the solubility parameter of the second polymer is less than 2.1, then when the casting solution formed by the second polymer penetrates into the porous substrate layer formed by the first polymer, the casting solution is easily miscible with the first polymer which has already been solidified in the porous substrate layer, such that more intermixing regions are generated in the bonding region. These regions will block or reduce the porosity of the original bonding region, thereby resulting in a significant decrease in the membrane flux of the virus-removal composite membrane.

A method for preparing a virus-removal composite membrane includes the following steps:
S1: preparing a prefabricated porous substrate membrane; wherein the PMI average pore size of the porous substrate layer is greater than or equal to 0.08 μm;
S2: preparing a casting solution and casting the casting solution onto a porous substrate layer; wherein part of the casting solution permeates and invades into the porous substrate membrane to form a bonding region, and the other part of the impermeable casting solution forms a liquid membrane;
wherein the casting solution has a viscosity of 3,000-50,000 cps and a solid content of 15% to 30%; the separation layer is prepared from the casting solution by a solvent phase separation method, wherein the casting solution includes 15-30 parts of polyethersulfone, 50-100 parts of organic solvents, and 5-25 parts of polar additives; and
S3: solidifying using a solidifying solution; and immersing the liquid membrane and the porous substrate layer into the solidifying solution for at least 10 seconds.

Further, the surface energy of the casting solution is less than the surface energy of the porous substrate layer, and the difference between the surface energy of the porous substrate layer and the surface tension of the casting solution is greater than 20 dynes/cm.

Further, the casting solution has a viscosity of 8,000-20,000 cps and a solid content of 18% to 26%.

In the present disclosure, the casting solution is cast onto a prefabricated porous substrate layer, and the casting solution partially permeates into the porous substrate layer to form a bonding region, and the bonding region enhances the connectivity between the porous substrate layer and the separation layer as well as the bonding strength between the porous substrate layer and the separation layer.

On the one hand, the viscosity of the casting solution has a great influence on the membrane layer structure finally formed by the separation layer, and on the other hand, the viscosity of the casting solution also has a great influence on the formation of the bonding region. Secondly, the pore size of the porous substrate layer determines the permeation degree of the casting solution and the effect of permeation (e.g. the difference in permeation speed between the solute and the solvent, and the uniformity of the thickness of the bonding region formed by permeation). Furthermore, the difference between the surface energy of the porous substrate layer and the surface energy of the casting solution also has an influence on permeation of the casting solution on the porous substrate layer. The permeation process is a process that reduces the surface energy, so if the difference between the two is small, then the permeation effect becomes poorer.

Therefore, in the present disclosure, by controlling the viscosity of the casting solution and the average pore size of the porous substrate layer, and by controlling the difference between the surface energy of the porous substrate layer and the surface energy of the casting solution to be greater than 20 dynes/cm, the thickness of the bonding region formed when the casting solution permeates into the porous substrate layer is more moderate, and the connectivity and the bonding strength between the separation layer and the porous substrate layer are dramatically improved.

Further, the membrane-forming material is selected from one of polyethersulfone (PES), polyvinylidene fluoride (PVDF), cellulose acetate (CA) and regenerated cellulose (RC), and the porous substrate layer includes a supporting membrane layer made from one of nylon, PVDF, polytetrafluoroethylene (PTFE), PES, CA and polyethylene (PE) and configured to be bonded with the separation layer.

Further, the porous substrate layer further comprises a non-woven layer arranged on one side of the supporting membrane layer facing away from the separation layer.

Further, the porous substrate layer is a supporting membrane layer made of a non-woven fabric.

Further, the organic solvent is at least one of butyl lactate, dimethyl sulfoxide, dimethylformamide, caprolactam, methyl acetate, ethyl acetate, N-ethyl pyrrolidone, diethyl phthalate, dimethylacetamide, acetone, and N-methyl pyrrolidone; and the polar additive is at least one of acetamide, polyvinyl alcohol, polyethylene glycol, and polyvinylpyrrolidone.

Further, the solidifying solution includes water and a permeation additive, wherein the content of the permeation additive is 25-70%; and the permeation additive is at least one of isopropanol, ethanol and ethylene glycol.

By adding a permeation additive to the solidifying solution, in a process of phase inversion of casting solution to form a membrane layer, after a convex with a smaller pore size is formed on the surface of the separation layer, an excessively strong obstruction effect on the solidifying solution is prevented, thereby leading to a poorer phase inversion effect of the casting solution in the transition region of the separation layer and in the bonding region of the porous substrate layer. When a larger pore is possibly formed in the transition region, the pore size of the separation layer is changed with a great gradient, and the pre-filtration effect becomes poorer. Coarse fibers may also be formed in the bonding region, such that the flux in the bonding region is dramatically decreased.

Therefore, permeation additives are added to the solidifying solution in order to obtain a separation layer with less change gradient as well as a bonding region with better connectivity.

In summary, the present disclosure has the following beneficial effects.

The casting solution is cast on the prefabricated porous substrate layer to form a separation layer for separating viruses, and at the same time, a bonding region with moderate thickness, good morphology and excellent connectivity is formed in the region, close to the separation layer, of the porous substrate layer, such that under the premise that the virus-removal composite membrane may play a better role in removing viruses and pre-filtering, the membrane flux of the virus-removal composite membrane and the bonding strength of the separation layer are both improved. The virus-removal composite membrane of the present disclosure is capable of satisfying the applications in the fields of biological material separation, such as the field of virus removal. Moreover, compared with other processes, the preparation process of the virus-removal composite membrane is simpler in preparation process and higher in economic effects.

### BRIEF DESCRIPTION OF THE DRAWINGS

The present disclosure is further described below in combination with the accompanying drawings.

FIG. 1 is a scanning electron microscope (SEM) diagram of a cross section of a virus-removal composite membrane prepared in Embodiment 1 of the present disclosure, with a magnification of 300×;

FIG. 2 is a scanning electron microscope (SEM) diagram of a cross section of a virus-removal composite membrane prepared in Embodiment 1 of the present disclosure, with a magnification of 700×;

FIG. 3 is a scanning electron microscope (SEM) diagram of a cross section of a bonding region of the virus-removal composite membrane prepared in Embodiment 1 of the present disclosure, with a magnification of 20 K×;

FIG. 4 is a scanning electron microscope (SEM) diagram of a cross section of a bonding region of the virus-removal composite membrane prepared in Embodiment 1 of the present disclosure, with a magnification of 50 K×;

FIG. 5 is a scanning electron microscope (SEM) diagram of a cross section of a virus-removal composite membrane prepared in Embodiment 17 of the present disclosure, with a magnification of 700×;

FIG. 6 is a scanning electron microscope (SEM) diagram of a cross section of a bonding region of the virus-removal composite membrane prepared in Embodiment 17 of the present disclosure, with a magnification of 5 K×;

FIG. 7 is a scanning electron microscope (SEM) diagram of a cross section of the virus-removal composite membrane prepared in Comparative Embodiment 1 of the present disclosure, with a magnification of 5 K×;

FIG. 8 is a scanning electron microscope (SEM) diagram of a liquid outlet surface of the virus-removal composite membrane prepared in Embodiment 1 of the present disclosure, with a magnification of 20 K×; and

FIG. 9 is a schematic diagram of a flux testing apparatus of the virus-removal composite membrane of the present disclosure.

### DETAILED DESCRIPTION OF THE EMBODIMENTS

For a clearer understanding of the above objectives, features and advantages of the present disclosure, the present disclosure will be described in further detail below in combination with the accompanying drawings and specific embodiments. It should be noted that the embodiments and features in the embodiments of the present disclosure may be combined with each other without conflict. Wherein, a scanning electron microscope with a model of S-5500 provided by Hitachi, Ltd. is used to characterize the structural morphology of the filter membrane.

Many specific details are set forth in the following description in order to facilitate a full understanding of the present disclosure, however, the present disclosure may also be implemented in other ways different from those described herein, and therefore, the scope of the protection of the present disclosure is not limited by specific embodiments disclosed below.

### Embodiment 1

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 90 μm;
S2: preparing a casting solution, wherein the casting solution includes the following components in parts by weight: 20 parts of polyethersulfone, 75 parts of organic solvent butyl lactate, and 15 parts of polar additive polyvinyl alcohol; and the casting solution has a viscosity of 11,000 cps and a solid content of 20%;
S3: casting a casting solution, and casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein phase separation and solidification last for 20 seconds.

### Embodiment 2

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 20 parts of polyethersulfone, 75 parts of organic solvent butyl lactate, and 15 parts of polar additive polyvinyl alcohol; and the casting solution has a viscosity of 8,000 cps and a solid content of 18%;
S3: casting a casting solution, and casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein phase separation and solidification last for 20 seconds.

### Embodiment 3

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 26 parts of polyethersulfone, 90 parts of organic solvent dimethylsulfoxide, and 20 parts of polar additive polyvinyl alcohol; and the casting solution has a viscosity of 13,000 cps and a solid content of 21%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 25% of ethanol permeation additive; and phase separation and solidification last for 20 seconds.

### Embodiment 4

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 17 parts of polyethersulfone, 62 parts of organic solvent dimethylformamide, and 10 parts of polar additive polyethylene glycol; and the casting solution has a viscosity of 18,000 cps and a solid content of 20%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 29% of isopropanol permeation additive; and phase separation and solidification last for 20 seconds.

### Embodiment 5

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 20 parts of polyethersulfone, 75 parts of organic solvent caprolactam, and 15 parts of polar additive polyvinyl alcohol; and the casting solution has a viscosity of 14,000 cps and a solid content of 20%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 31% of ethanol permeation additive; and phase separation and solidification last for 20 seconds.

### Embodiment 6

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 19 parts of polyethersulfone, 71 parts of organic solvent methyl acetate, and 13 parts of polar additive polyvinyl alcohol; and the casting solution has a viscosity of 10,000 cps and a solid content of 18%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 28% of ethanol permeation additive; and phase separation and solidification last for 20 seconds.

### Embodiment 7

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 18 parts of polyethersulfone, 67 parts of organic solvent N-ethyl pyrrolidone, and 11 parts of polar additive polyvinyl alcohol; and the casting solution has a viscosity of 22,000 cps and a solid content of 19%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 63% of isopropanol permeation additive; and phase separation and solidification last for 20 seconds.

### Embodiment 8

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 20 parts of polyethersulfone, 75 parts of organic solvent dimethylacetamide, and 15 parts of polar additive polyethylene glycol; and the casting solution has a viscosity of 15,000 cps and a solid content of 18%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 73% of ethanol permeation additive; and phase separation and solidification last for 20 seconds.

### Embodiment 9

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 21 parts of polyethersulfone, 77 parts of organic solvent N-methylpyrrolidone, and 16 parts of polar additive polyvinylpyrrolidone; and the casting solution has a viscosity of 24,000 cps and a solid content of 20%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 46% of glycol permeation additive; and phase separation and solidification last for 20 seconds.

### Embodiment 10

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 22 parts of polyethersulfone, 80 parts of organic solvent N-methylpyrrolidone, and 17 parts of polar additive polyvinylpyrrolidone; and the casting solution has a viscosity of 31,000 cps and a solid content of 21%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 50% of ethanol permeation additive; and phase separation and solidification last for 20 seconds.

### Embodiment 11

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 28 parts of polyethersulfone, 95 parts of organic solvent N-ethyl pyrrolidone, and 22 parts of polar additive polyethylene glycol; and the casting solution has a viscosity of 17,000 cps and a solid content of 22%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 27% of ethanol permeation additive; and phase separation and solidification last for 20 seconds.

### Embodiment 12

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 19 parts of polyethersulfone, 71 parts of organic solvent methyl acetate, and 13 parts of polar additive polyethylene glycol; and the casting solution has a viscosity of 11,000 cps and a solid content of 18%;
S3: casting a casting solution, casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification; wherein the coagulating bath is an aqueous solution containing 32% of glycol permeation additive; and phase separation and solidification last for 23 seconds.

### Embodiment 13

Embodiment 13 differs from Embodiment 11 in that the porous substrate layer has a PMI average pore size of 0.1 μm and a thickness of 100 μm.

### Embodiment 14

Embodiment 14 differs from Embodiment 11 in that the porous substrate layer has a PMI average pore size of 0.4 μm and a thickness of 130 μm.

### Embodiment 15

Embodiment 15 differs from Embodiment 11 in that the porous substrate layer has a PMI average pore size of 0.6 μm and a thickness of 150 μm.

### Embodiment 16

Embodiment 16 differs from Embodiment 11 in that the porous substrate layer has a PMI average pore size of 0.1 μm and a thickness of 200 μm.

### Embodiment 17

Embodiment 17 differs from Embodiment 1 in that the porous substrate layer is made of a PVDF microporous membrane.

### Embodiment 18

Embodiment 18 differs from Embodiment 1 in that the porous substrate layer is made of a microporous membrane of a CA material.

### Embodiment 19

Embodiment 19 differs from Embodiment 1 in that the porous substrate layer is made of a microporous membrane of a PTFE material.

### Embodiment 20

Embodiment 20 differs from Embodiment 1 in that the porous substrate layer is made of a microporous membrane of a PE material.

### Embodiment 21

Embodiment 21 differs from Embodiment 11 in that the porous substrate layer is made of a microporous membrane with an average pore size change gradient of 1 nm/μm. The SEM average pore size on the surface of the large pore side is 0.6 μm, the SEM average pore size on the surface of the small pore side is 0.49 μm, and the separation layer is cast on the small pore side of the porous substrate layer.

### Embodiment 22

Embodiment 22 differs from Embodiment 11 in that the porous substrate layer is made of a microporous membrane with an average pore size change gradient of 1 nm/μm. The SEM average pore size on the surface of the large pore side is 0.6 μm, the SEM average pore size on the surface of the small pore side is 0.49 μm, and the separation layer is cast on the large pore side of the porous substrate layer.

### Embodiment 23

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 15 parts of cellulose diacetate, 1 part of polyvinylpyrrolidone, 26 parts of acetamide, 29.4 parts of acetone and 28 parts of dimethylacetamide;
S3: casting a casting solution, and casting the casting solution onto a porous substrate layer, wherein part of the casting solution permeates and invades into the porous substrate membrane to form a bonding region, and the other part of the impermeable casting solution forms a liquid membrane;
S4: performing solidification and phase separation, i.e., immersing the porous substrate membrane after casting the casting solution into coagulating bath water for phase separation and solidification; and
S5: hydrolyzing the membrane after phase separation in step S3 in 0.02 mol/L sodium hydroxide aqueous solution at 50° C. for 6 h, and verifying by infrared rays that the carbonyl peak of cellulose acetate at 1740 cm disappeared completely.

### Embodiment 24

Embodiment 24 differs from Embodiment 23 in that the porous substrate layer is made of a microporous membrane of a PVDF material.

### Embodiment 25

Embodiment 25 differs from Embodiment 23 in that the porous substrate layer is made of a microporous membrane of a PTFE material.

### Embodiment 26

Embodiment 26 differs from Embodiment 23 in that the porous substrate layer is made of a microporous membrane of a PES material.

### Embodiment 27

Embodiment 27 differs from Embodiment 23 in that the porous substrate layer is made of a microporous membrane of a PE material.

### Embodiment 28

A method for preparing a virus-removal composite membrane includes the following steps:
S1: preparing a prefabricated porous substrate membrane; wherein the porous substrate is a nylon microporous membrane; and the porous substrate layer has a PMI average pore size of 0.22 μm and a thickness of 110 μm;
S2: preparing a casting solution, wherein the casting solution includes the following components in parts by weight: 25 parts of polyvinylidene fluoride, and 75 parts of diethyl phthalate;
S3: casting a casting solution, and casting the casting solution onto a porous substrate layer, wherein part of the casting solution permeates and invades into the porous substrate membrane to form a bonding region, and the other part of the impermeable casting solution forms a liquid membrane; and
S4: performing solidification and phase separation, i.e., immersing the porous substrate membrane after casting the casting solution into coagulating bath water for phase separation and solidification.

### Embodiment 29

Embodiment 29 differs from Embodiment 28 in that the porous substrate layer is made of a microporous membrane of a PTFE material.

### Embodiment 30

Embodiment 30 differs from Embodiment 28 in that the porous substrate layer is made of a microporous membrane of a PE material.

### Embodiment 31

Embodiment 31 differs from Embodiment 28 in that the porous substrate layer is made of a microporous membrane of a PES material.

### Embodiment 32

Embodiment 32 differs from Embodiment 28 in that the porous substrate layer is made of a microporous membrane of a CA material.

### Embodiment 33

Embodiment 33 differs from Embodiment 1 in that the porous substrate layer is made of a nylon microporous membrane compounded with a non-woven fabric.

### Comparative Embodiment 1

Comparative Embodiment 1 differs from Embodiment 1 in that the porous substrate membrane is a nylon microporous membrane with a PMI average pore size of 0.05 μm and a thickness of 110 μm.

### Comparative Embodiment 2

Comparative Embodiment 2 differs from Embodiment 1 in that the porous substrate membrane is a polyethersulfone microporous membrane with a PMI average pore size of 0.05 μm and a thickness of 110 μm.

### I. Structural Characterization

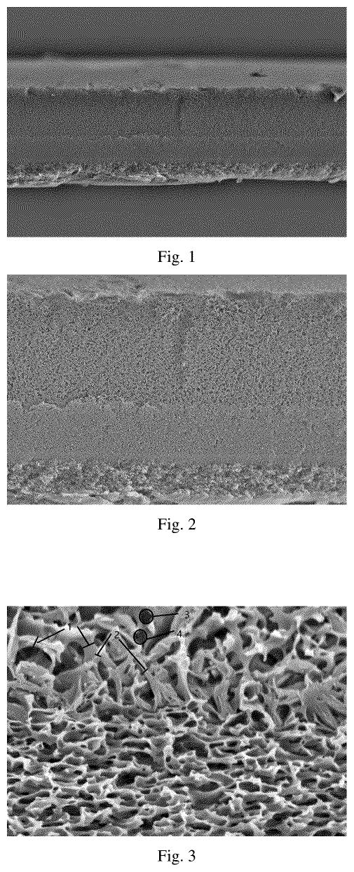

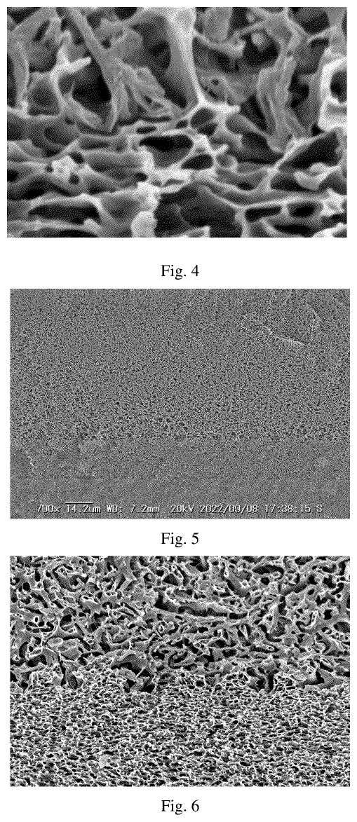

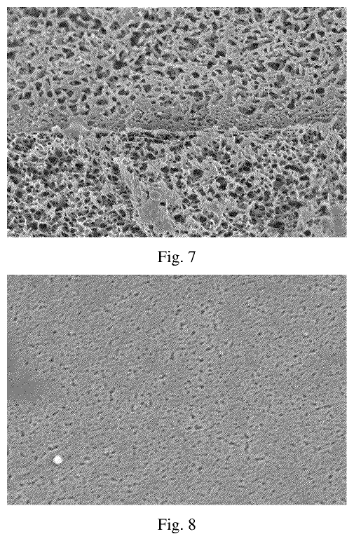

The membrane structures of nanoscale polymer filter membranes obtained from each embodiment were subjected to morphology characterization using a scanning electron microscope, and then the required data were obtained. The results are shown in FIG. 1 to FIG. 8, among which FIG. 1, FIG. 2, FIG. 3, and FIG. 4 are SEM images of the cross-section of the virus-removing composite membrane prepared in Embodiment 1, with a magnification of 300×, 700×, 20 K×, and 50 K×, respectively. In FIG. 3, 1 represents the diameter of the first fiber within the bonding region, 2 represents the diameter of the second fiber within the bonding region, and 3 and 4 represent the pores measured within the bonding region. FIG. 5 and FIG. 6 are SEM images of the cross-section of the virus-removing composite membrane prepared in Embodiment 17, with a magnification of 700× and 5 K×, respectively. FIG. 7 and FIG. 8 are SEM images of the cross-section of the virus-removing composite membrane prepared in Comparative Embodiment 1, with a magnification of 5 K× and 20 K×, respectively.

Surface tension test method: samples were taken from the casting solution and the surface tension of the casting solution was tested using a capillary method; wherein the surface tension of the prefabricated porous substrate membrane is a critical surface tension value, a contact angle cosine value-liquid gram molecular volume diagram may be made by measuring a contact angle between the liquid of known surface tension and a porous substrate membrane, and the critical surface tension is obtained by extrapolating the figure to the position where the cosine value is 1.

Specific results are shown in the following table.

TABLE 1

| | | | SEM average | Thickness | SEM average |
|---|---|---|---|---|---|
| | Difference in | Thickness of | pore size of | standard | pore size at |
| | surface tension | the bonding | the bonding | deviation | the boundary |
| Embodiments | (dyne/cm) | region (μm) | region (μm) | (μm) | (nm) |
| Embodiment | 36.8 | 30.54 | 0.14 | 0.5 | 53 |
| 1 | | | | | |
| Embodiment | 32.7 | 33.97 | 0.12 | 1.5 | 52 |
| 2 | | | | | |
| Embodiment | 22.4 | 22.64 | 0.09 | 1 | 58 |
| 3 | | | | | |
| Embodiment | 40.3 | 42.33 | 0.13 | 2.9 | 52 |
| 4 | | | | | |
| Embodiment | 36.0 | 37.60 | 0.08 | 2.3 | 60 |
| 5 | | | | | |
| Embodiment | 44.2 | 46.62 | 0.14 | 3.8 | 54 |
| 6 | | | | | |
| Embodiment | 33.4 | 34.74 | 0.16 | 1.8 | 50 |
| 7 | | | | | |
| Embodiment | 40.7 | 42.77 | 0.15 | 2.8 | 53 |
| 8 | | | | | |
| Embodiment | 32.3 | 33.53 | 0.17 | 1.2 | 57 |
| 9 | | | | | |
| Embodiment | 30.3 | 32.54 | 0.14 | 1.6 | 54 |
| 10 | | | | | |
| Embodiment | 31.4 | 31.10 | 0.11 | 2.1 | 50 |
| 11 | | | | | |
| Embodiment | 42.2 | 45.21 | 0.15 | 4.5 | 50 |
| 12 | | | | | |

In the above table, the difference in surface tension represents: surface tension of the porous substrate layer-surface tension of the casting solution.

SEM average aperture at the boundary represents: the distance between one side, close to the separation layer, of the bonding region and the separation layer is less than 20% of the average pore size in the thickness region of the bonding region measured by an SEM.

TABLE 2

| | SEM average | | | |
|---|---|---|---|---|
| | diameter of | SEM average | | |
| | the first | diameter of the | | |
| Embodiments | fiber (μm) | second fiber (μm) | Ratio 1 | Ratio 2 |
| Embodiment 1 | 0.16 | 0.068 | 1.14 | 0.49 |
| Embodiment 2 | 0.15 | 0.089 | 1.25 | 0.74 |
| Embodiment 3 | 0.14 | 0.096 | 1.56 | 1.07 |
| Embodiment 4 | 0.17 | 0.076 | 1.31 | 0.58 |
| Embodiment 5 | 0.17 | 0.064 | 2.13 | 0.80 |
| Embodiment 6 | 0.15 | 0.069 | 1.07 | 0.49 |
| Embodiment 7 | 0.14 | 0.081 | 0.88 | 0.51 |
| Embodiment 8 | 0.16 | 0.074 | 1.07 | 0.49 |
| Embodiment 9 | 0.14 | 0.094 | 0.82 | 0.55 |
| Embodiment 10 | 0.16 | 0.082 | 1.14 | 0.59 |
| Embodiment 11 | 0.17 | 0.08 | 1.55 | 0.73 |
| Embodiment 12 | 0.19 | 0.062 | 1.27 | 0.41 |

Ratio 1 represents: the ratio of the average diameter of the first fiber measured by an SEM to the average pore size of the bonding region measured by an SEM.

Ratio 2 represents: the ratio of the average diameter of the second fiber measured by an SEM to the average pore size of the bonding region measured by an SEM.

TABLE 3

| | | | | SEM pore | Pore area |
|---|---|---|---|---|---|
| | Thickness of | Thickness of the | Thickness of | size of the | ratio of the |
| | separation | virus-removal | the transition | liquid outlet | liquid outlet |
| Embodiments | layer (μm) | region (μm) | region (μm) | surface (nm) | surface (%) |
| Embodiment | 19.23 | 3.03 | 16.20 | 21 | 8 |
| 1 | | | | | |
| Embodiment | 36.93 | 3.6 | 33.33 | 26 | 11 |
| 2 | | | | | |
| Embodiment | 40.21 | 1.4 | 38.6 | 30 | 5 |
| 3 | | | | | |
| Embodiment | 15.39 | 1.7 | 13.69 | 29 | 7 |
| 4 | | | | | |
| Embodiment | 23.23 | 3.5 | 19.73 | 26 | 12 |
| 5 | | | | | |
| Embodiment | 14.53 | 2.9 | 11.63 | 24 | 5 |
| 6 | | | | | |
| Embodiment | 31.29 | 1.6 | 29.69 | 28 | 12 |
| 7 | | | | | |
| Embodiment | 17.72 | 2.7 | 15.02 | 21 | 8 |
| 8 | | | | | |
| Embodiment | 40.51 | 3.1 | 37.41 | 18 | 5 |
| 9 | | | | | |
| Embodiment | 29.35 | 2.8 | 26.55 | 24 | 8 |
| 10 | | | | | |
| Embodiment | 26.93 | 3.7 | 23.23 | 23 | 10 |
| 11 | | | | | |
| Embodiment | 12.54 | 1.1 | 11.44 | 23 | 10 |
| 12 | | | | | |

A tensile test, a membrane flux test, a virus retention test, and a protein yield test were performed on the virus-removal composite membranes of Embodiments 1-11 and Comparative Embodiments 1-2.

### Membrane Tensile Test Method

The tensile test was performed using a universal tensile testing machine, with a sample width of 10 mm, a sample gauge length of 50 mm, and a tensile speed of 20 mm/min.

### Membrane Flux Test Method

The membrane flux is calculated by the following equation:

The membrane flux (J) is calculated through the equation: J=V/(T×A) where:

J is the membrane flux unit: L*h⁻¹*m⁻²;

V represents sampling volume (L); T represents sampling time (h); and A represents membrane effective area (m²).

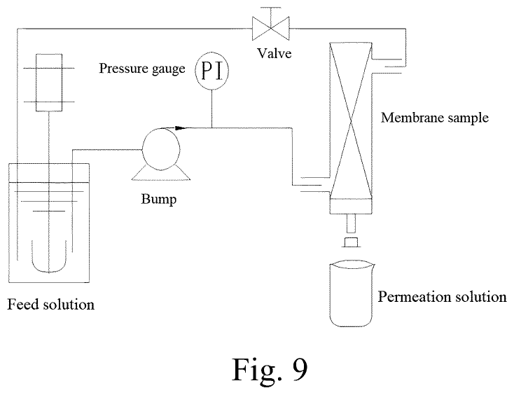

The operating conditions used for measuring the membrane flux of the virus-removal composite membrane in the present disclosure are as follows: the inlet solution is de-ionized water, the operating pressure is 30 psi, the operating temperature is 25° C., and the pH value of the solution is 7; and the flux testing apparatus is shown in FIG. 9.

### Virus Retention Test Method

A virus retention test was performed according to the test method used in paragraph 114 of CN201010154974.7 entitled Ultrafiltration Membrane and Preparation Method Thereof; and the used virus was murine parvovirus with a particle size of 20 nm.

### Protein Yield Test Method

The protein yield test was performed according to the protein yield test method used in CN201010154974.7 entitled Ultra Porous Membrane and Preparation Method Thereof, or other methods may also be used.

TABLE 4

| | Tensile | Elongation | | Protein |
|---|---|---|---|---|
| | strength | at break | Membrane flux | yield |
| Embodiments | (MPa) | (%) | (L*h⁻¹*m⁻²@30 psi) | (%) |
| Embodiment | 3.15 | 7.2 | 1062 | 98 |
| 1 | | | | |
| Embodiment | 3.77 | 6.31 | 890 | 98 |
| 2 | | | | |
| Embodiment | 4.73 | 4.30 | 980 | 99 |
| 3 | | | | |
| Embodiment | 4.72 | 8.83 | 1100 | 98 |
| 4 | | | | |
| Embodiment | 4.63 | 9.72 | 1430 | 99 |
| 5 | | | | |
| Embodiment | 4.07 | 8.2 | 1060 | 98 |
| 6 | | | | |
| Embodiment | 4.83 | 6.08 | 1120 | 98 |
| 7 | | | | |
| Embodiment | 3.98 | 9.20 | 1250 | 98 |
| 8 | | | | |
| Embodiment | 3.41 | 5.05 | 980 | 99 |
| 9 | | | | |
| Embodiment | 4.17 | 4.80 | 1010 | 98 |
| 10 | | | | |
| Embodiment | 4.63 | 6.60 | 1030 | 99 |
| 11 | | | | |
| Embodiment | 3.97 | 8.11 | 1500 | 99 |
| 12 | | | | |
| Embodiment | 3.10 | 4.81 | 940 | 98 |
| 13 | | | | |
| Embodiment | 5.41 | 6.91 | 1020 | 98 |
| 14 | | | | |
| Embodiment | 6.48 | 7.36 | 1220 | 97 |
| 15 | | | | |
| Embodiment | 7.21 | 7.65 | 1380 | 98 |
| 16 | | | | |
| Embodiment | 4.79 | 6.83 | 930 | 97 |
| 17 | | | | |
| Embodiment | 4.07 | 6.12 | 970 | 97 |
| 18 | | | | |
| Embodiment | 4.58 | 6.34 | 950 | 98 |
| 19 | | | | |
| Embodiment | 4.62 | 6.16 | 960 | 98 |
| 20 | | | | |
| Embodiment | 4.11 | 5.68 | 880 | 99 |
| 21 | | | | |
| Embodiment | 4.52 | 6.34 | 1140 | 98 |
| 22 | | | | |
| Embodiment | 4.24 | 6.21 | 1020 | 98 |
| 23 | | | | |
| Embodiment | 4.16 | 6.33 | 1040 | 98 |
| 24 | | | | |
| Embodiment | 4.26 | 6.28 | 1110 | 99 |
| 25 | | | | |
| Embodiment | 4.34 | 6.26 | 1120 | 98 |
| 26 | | | | |
| Embodiment | 4.29 | 6.34 | 1090 | 98 |
| 27 | | | | |
| Embodiment | 4.16 | 6.26 | 1160 | 97 |
| 28 | | | | |
| Embodiment | 4.38 | 6.32 | 1130 | 98 |
| 29 | | | | |
| Embodiment | 4.25 | 6.27 | 1040 | 97 |
| 30 | | | | |
| Embodiment | 4.36 | 6.31 | 1160 | 98 |
| 31 | | | | |
| Embodiment | 4.28 | 6.42 | 1130 | 98 |
| 32 | | | | |
| Embodiment | 4.37 | 6.33 | 1034 | 98 |
| 33 | | | | |
| Comparative | / | / | 160 | / |
| Embodiment | | | | |
| 1 | | | | |
| Comparative | / | / | 210 | / |
| Embodiment | | | | |
| 2 | | | | |

The virus retention efficiency LRV in Embodiment 1 to Embodiment 33 are all greater than 2, indicating that the virus-removal composite membrane prepared in the present disclosure has higher virus retention efficiency. Secondly, in particular, the virus retention efficiency of Embodiment 4 and Embodiment 10 may be greater than 4. The possible reason lies in that the integrity of the separation layer in these two groups of embodiments is better, and the retention efficiency of the virus is higher. As to the virus-removal composite membranes that do not have an LRV of greater than 4, it is found that an LRV of greater than 4 may also be achieved when two layers are stacked for filtration.

Conclusions: in the present disclosure, a comparison between Embodiment 1 and Comparative Embodiments 1 and 2 clearly shows a sharp decrease in the membrane flux, and it can be seen from the electron micrographs of the two that non-desired accumulation appears at the boundary of the two layers of membranes in Comparative Embodiment 1, thereby leading to a great influence on the membrane flux.

Secondly, it can be seen from the structural characterization parameters of Embodiments 1 to 12 of the present disclosure that, while conforming to the range of parameters of the bonding region disclosed in the present disclosure, the virus-removal composite membrane prepared in the present disclosure is capable of taking into account the mechanical strength, the membrane flux, the viral retention efficiency, and the protein yield, and the test results thereof are all superior. Specifically, it can be seen from the structural parameters of the bonding region of the composite membrane that, the thickness of the bonding region, the average pore size of the bonding region, and the first fiber and the second fiber in the bonding region have a more obvious influence on the connectivity of the bonding region and on the bonding strength between the separation layer and the porous substrate layer. When the above parameters of the bonding region satisfy the requirements of the present disclosure, it means that the morphological structure in the bonding region are more suitable for the composition of the virus-removal composite membrane with a good retention efficiency for tiny viruses of the present disclosure, such that the mechanical strength, the membrane flux, and the protein yield of the virus-removal composite membrane all reach a higher level.

In the present disclosure, a polyethersulfone casting solution with a difference in surface tension of less than 20 dynes/cm and a nylon porous substrate layer with a PMI average pore size of 0.2 μm are coated to prepare a virus-removal composite membrane, and it is found that the bonding region of the virus-removal composite membrane is merely permeable in the range of 2-5 μm, and that the membrane flux of the resulting membrane layer tends to be 0. It indicates that when the difference in surface tension is too small, the permeation of the casting solution is extremely difficult, and the bonding region in the present disclosure is unable to be formed basically.

Preferred embodiments of the present disclosure have been described in detail above, however, it should be understood that after reading the above contents of the present disclosure, various changes or modifications may be made to the present disclosure by those skilled in the art. These equivalent forms also fall within the scope defined by the claims appended to the present disclosure.

What is claimed is:

1. A virus-removal composite membrane, comprising a main body, wherein an outer surface on one side of the main body is a liquid inlet surface, an outer surface on another side is a liquid outlet surface, and the main body comprises:
a porous substrate layer including the liquid inlet surface and a separation layer including the liquid outlet surface, wherein an average pore size of the porous substrate layer is greater than an average pore size of the separation layer;
the porous substrate layer is a microporous membrane layer formed by a first polymer, the separation layer is formed by a second polymer, and the first polymer and the second polymer are different polymer materials;
in a region of the porous substrate layer close to one side of the separation layer, the second polymer permeates from a surface of the porous substrate layer into a pore structure of the porous substrate layer to form a bonding region, and pores formed by the second polymer in the bonding region are connected to pores of the separation layer; and
a PMI average pore size of the virus-removal composite membrane is controlled to be 15-25 nm; and an average pore size of the bonding region measured by a scanning electron microscope (SEM) is greater than or equal to 50 nm.

2. The virus-removal composite membrane according to claim 1, wherein the average pore size of the bonding region measured by an SEM is 50-500 nm, and a thickness of the bonding region is greater than or equal to 10 μm.

3. The virus-removal composite membrane according to claim 1, wherein the thickness of the bonding region accounts for 30-70% of a thickness of the porous substrate layer, and the thickness of the bonding region is 15-30 μm.

4. The virus-removal composite membrane according to claim 1, wherein a ratio of the thickness of the bonding region to a thickness of the separation layer is 1:(0.5-2).

5. The virus-removal composite membrane according to claim 1, wherein the thickness of the bonding region has a standard deviation σ of less than or equal to 3 μm in a length direction and/or a width direction.

6. The virus-removal composite membrane according to claim 1, wherein the bonding region comprises a first fiber formed from the first polymer, and a second fiber formed from the second polymer; and a SEM average diameter of the first fiber within the bonding region is 0.1 μm to 2 μm, and a SEM average diameter of the second fiber within the bonding region is 0.05 μm to 1 μm.

7. The virus-removal composite membrane according to claim 6, wherein a ratio of the SEM average diameter of the first fiber within the bonding region to the average pore size of the bonding region measured by an SEM is 0.5-2.5, a ratio of the SEM average diameter of the second fiber within the bonding region to the average pore size of the bonding region measured by an SEM is 0.4-0.9, and the average pore size of the bonding region measured by an SEM is 80 nm to 200 nm.

8. The virus-removal composite membrane according to claim 1, wherein a ratio of the SEM average pore size of the bonding region to the SEM average pore size of the porous substrate layer is 1:(3-20) in the region where the bonding region is close to the side of the separation layer and the distance from the separation layer is less than 20% of the thickness of the bonding region.

9. The virus-removal composite membrane according to claim 1, wherein the thickness of the separation layer is greater than or equal to 10 μm.

10. The virus-removal composite membrane according to claim 1, wherein the thickness of the separation layer is 10-40 μm, and the pore size of the separation layer decreases in a gradient manner in a thickness direction towards the liquid outlet surface; and the separation layer comprises a virus-removal region and a transition region in the thickness direction, and a thickness ratio of the transition region to the virus-removal region is 3-20.

11. The virus-removal composite membrane according to claim 10, wherein a ratio of a thickness of the transition region to the thickness of the bonding region is 0.2-4, an average pore size of the transition region measured by an SEM is 50-100 nm, and the average pore size of the bonding region measured by an SEM is 50-200 nm.

12. The virus-removal composite membrane according to claim 1, wherein an average pore size of the liquid outlet surface measured by an SEM is 15-40 nm; and a pore area ratio of the liquid outlet surface is 2% to 15%.

13. The virus-removal composite membrane according to claim 1, wherein the average pore size of the porous substrate layer measured by an SEM is greater than or equal to 80 nm, and the thickness of the porous substrate layer is 20-200 μm.

14. The virus-removal composite membrane according to claim 1, wherein the porous substrate layer is an asymmetric membrane layer structure.

15. The virus-removal composite membrane according to claim 14, wherein the pore size of the porous substrate layer increases in a gradient manner in a direction from the liquid inlet surface towards the bonding region.

16. The virus-removal composite membrane according to claim 15, wherein the average pore size of the porous substrate layer is changed with a gradient of 1-6 nm/μm.

17. The virus-removal composite membrane according to claim 1, wherein the porous substrate layer is a symmetric membrane layer structure.

18. The virus-removal composite membrane according to claim 1, wherein a tensile strength of the virus-removal composite membrane is greater than 3 MPa and an elongation at break is 2% to 10%;
a flux of the virus-removal composite membrane is greater than
600 L*h⁻¹*m⁻²@30 psi;
a log reduction value (LRV) of the virus-removal composite membrane for virus impurities is greater than or equal to 2; and
a protein yield of the virus-removal composite membrane is greater than or equal to 97%.

19. The virus-removal composite membrane according to claim 1, wherein the LRV of the virus-removal composite membrane for virus impurities is 2-4.

20. The virus-removal composite membrane according to claim 1, wherein a difference between a solubility parameter of the first polymer and a solubility parameter of the second polymer is greater than or equal to 2.1.

21. A method for preparing a virus-removal composite membrane, comprising the following steps:
S1: preparing a prefabricated porous substrate membrane; wherein the PMI average pore size of the porous substrate layer is greater than or equal to 0.08 μm;
S2: preparing a casting solution and casting the casting solution onto a porous substrate layer; wherein part of the casting solution permeates and invades into the porous substrate membrane to form a bonding region, and the other part of the impermeable casting solution forms a liquid membrane;
wherein the casting solution has a viscosity of 3,000-50,000 cps and a solid content of 15% to 30%; and the separation layer is prepared from the casting solution by a non-solvent phase separation method, wherein the casting solution comprises 15-30 parts of membrane-forming materials, 50-100 parts of organic solvents, and 5-25 parts of polar additives; and
S3: solidifying using a solidifying solution; and immersing the liquid membrane and the porous substrate layer into the solidifying solution for at least 10 seconds.

22. The method for preparing the virus-removal composite membrane according to claim 21, wherein the surface tension of the casting solution is less than the surface tension of the porous substrate layer, and the difference between the surface energy of the porous substrate layer and the surface tension of the casting solution is greater than 20 dynes/cm.

23. The method for preparing the virus-removal composite membrane according to claim 21, wherein the casting solution has a viscosity of 8,000-20,000 cps and a solid content of 18% to 26%.

24. The method for preparing the virus-removal composite membrane according to claim 21, wherein the membrane-forming material is selected from one of polyethersulfone (PES), polyvinylidene fluoride (PVDF), cellulose acetate (CA) and regenerated cellulose (RC), and the porous substrate layer comprises a supporting membrane layer made from one of nylon, PVDF, polytetrafluoroethylene (PTFE), PES, CA and polyethylene (PE) and configured to be bonded with the separation layer.

25. The method for preparing the virus-removal composite membrane according to claim 24, wherein the porous substrate layer further comprises a non-woven layer arranged on one side of the supporting membrane layer facing away from the separation layer.

26. The method for preparing the virus-removal composite membrane according to claim 21, wherein the porous substrate layer is a supporting membrane layer made of a non-woven fabric.

27. The method for preparing the virus-removal composite membrane according to claim 21, wherein the organic solvent is at least one of butyl lactate, dimethyl sulfoxide, dimethylformamide, caprolactam, methyl acetate, ethyl acetate, N-ethyl pyrrolidone, diethyl phthalate, dimethylacetamide, acetone, and N-methyl pyrrolidone; and the polar additive is at least one of acetamide, polyvinyl alcohol, polyethylene glycol, and polyvinylpyrrolidone.

28. The method for preparing the virus-removal composite membrane according to claim 21, wherein the solidifying solution comprises water and a permeation additive, wherein the content of the permeation additive is 25-70%; and the permeation additive is at least one of isopropanol, ethanol and ethylene glycol.
